(19) United States
(12) Patent Application Publication
(10) Pub. No.: US 2010/0273039 A1
(43) Pub. Date: Oct. 28, 2010

(54) BATTERY HOLDER AND ELECTRONIC DEVICE USING THE SAME

(75) Inventor: ZHI-HUA LIU, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/562,309

(22) Filed: Sep. 18, 2009

(30) Foreign Application Priority Data
Apr. 24, 2009 (CN) 200910301825.6

(51) Int. Cl. H01M 2/10

(52) U.S. Cl. 429/100

(57) ABSTRACT

A battery holder includes a main body defining a chamber therein and a latching groove in a middle portion of a sidewall of the chamber, and a spring for resisting the battery. The spring includes a latching portion engaged in the latching groove to fix the spring in the main body, such that the chamber is divided into a battery chamber and an additional chamber by the spring.

### CROSS-REFERENCE TO RELATED APPLICATIONS

This application is related to a co-pending U.S. patent application, and applications serial no. [to be determined], with Attorney Docket US27175, and entitled “BATTERY HOLDER FOR ELECTRONIC DEVICE”. The inventor of the co-pending application is Zhi-Hua Liu. The co-pending application has the same assignee as the present application.

### BACKGROUND

1. Technical Field

The present disclosure relates to battery holders, and particularly, to a battery holder for an electronic device.

2. Description of the Related Art

Electronic devices, such as wireless keyboards, flashlights, and other devices powered by batteries, utilize a battery holder fixing the batteries within the device.

A commonly used battery holder for a flashlight includes a main body, a front cover, a rear cover, a lamp socket, and a spring. The main body is substantially a cylindrical sleeve made of metallic material. The front cover and the rear cover are mounted in opposite ends of the main body. The lamp socket is fixed in the front cover. The spring is fixed in the rear cover. At least one battery is received in the main body, and electrically contacts the lamp socket and the spring. However, there is insufficient space to receive other elements, such as a circuit board.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is an isometric view of a first embodiment of an electronic device, the electronic device including an embodiment of a battery holder and an embodiment of a spring.

FIG. 2 is a partial, exploded, isometric view of the battery holder shown in FIG. 1.

FIG. 3 is a cross section of the electronic device shown in FIG. 1, taken along the line III-III.

FIG. 4 is an isometric view of the electronic device shown in FIG. 1 using a clamping member to assemble the electronic device.

FIG. 5 is a cross section of a second embodiment of an electronic device, the electronic device including another embodiment of a battery holder, another embodiment of a spring, and a battery.

FIG. 6 is a top view of the spring of the electronic device of FIG. 5.

### DETAILED DESCRIPTION

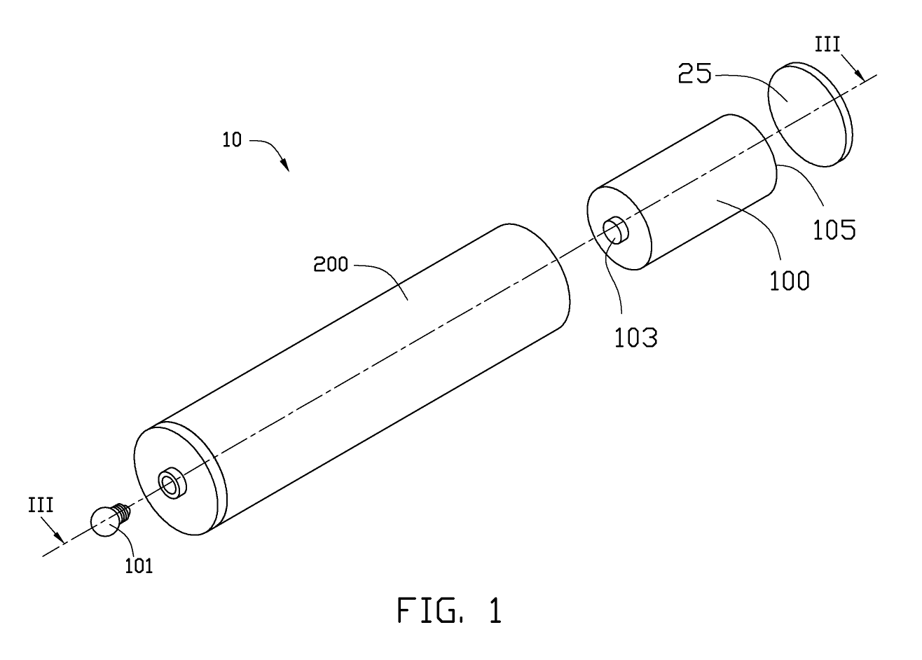

Referring to FIG. 1, a first embodiment of an electronic device 10 includes a battery 100, an embodiment of a battery holder 200, and a lamp 101 fixed to the battery holder 200. In the illustrated embodiment, the electronic device 10 is a flashlight, but can be any device supporting a battery holder such as a wireless keyboard or a remote control. The lamp 101 can be, but is not limited to, a bulb. The battery 100 includes a positive electrode 103 and a negative electrode 105 opposite to the positive electrode 103.

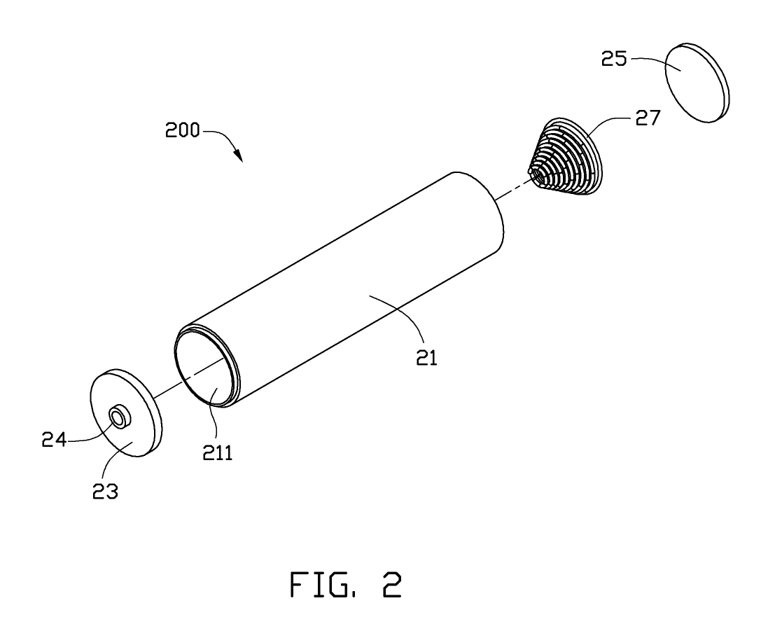

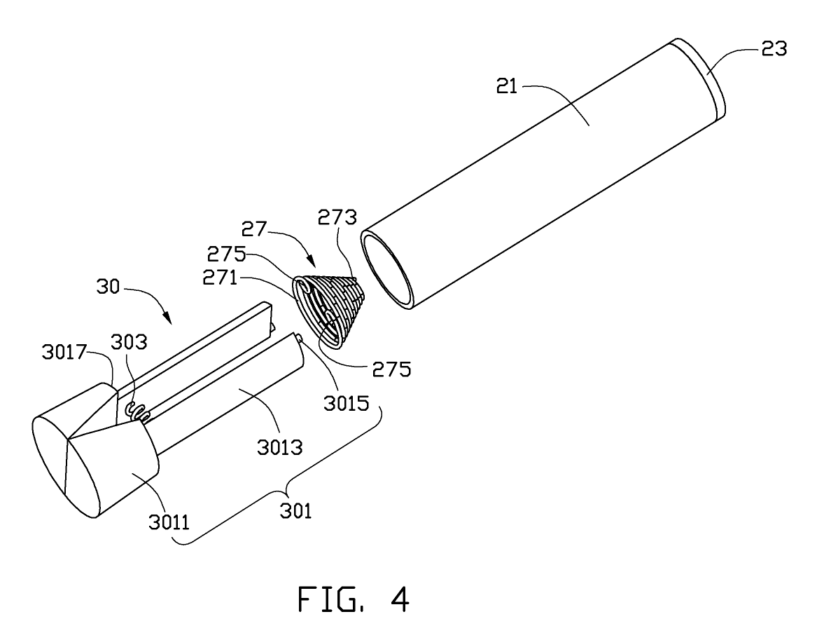

Referring to FIGS. 2 and 4, the battery holder 200 includes a main body 21, a front cover 23, a lamp socket 24, a rear cover 25, and a spring 27. The main body 21 can be hollow and substantially cylindrical. The main body 21 defines a chamber 211 to receive the battery 300 and the spring 27. The front cover 23 and the rear cover 25 are mounted in opposite ends of the main body 21. In the illustrated embodiment, the front cover 23 is permanently mounted in one end of the main body 21 by glue. Alternatively, the front cover 23 can be detachably mounted in the end of the main body 21 by fasteners such as screws. The lamp socket 24 is fixedly mounted in the front cover 23. The lamp 101 is detachably received in the lamp socket 24.

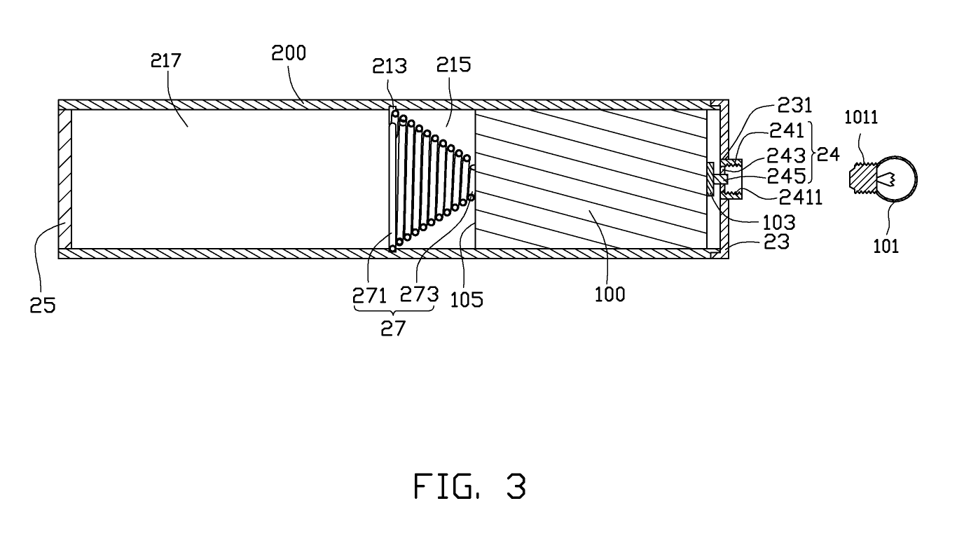

The main body 21 can be made of metallic material. Referring to FIG. 3, the main body 21 further defines a latching groove 213 in a middle portion of an inner sidewall of the chamber 211. In the illustrated embodiment, the latching groove 213 is an annular groove extending along a circumference of the chamber 211. The latching groove 213 can be easily formed by a T-shaped milling cutter.

The front cover 23 defines a fixing hole 231 in a middle portion thereof. In the illustrated embodiment, the front cover 23 is made of a metallic material.

The lamp socket 24 includes a sleeve 241, annular insulating sheet 243 and an electrical conductive pole 245. The sleeve 241 includes inner threading 2411 to engage with the corresponding threading 1011 of the lamp, such that the lamp may be detachably mounted in the sleeve 241. The insulating sheet 243 is positioned in an end of the sleeve 241. The electrical conductive pole 245 is received in the insulating sheet 243 and partially received in the sleeve 241. The electrical conductive pole 245 electrically interconnects the battery 300 and the lamp, and is insulated by the sleeve 241.

The spring 27 is substantially frustoconical in shape, and includes a latching portion 271 and a resisting portion 273. In the illustrated embodiment, the latching portion 271 is a large end of the spring 27. The resisting portion 273 is a small end of the spring 27. The spring 27 is compressed and the latching portion 271 of the spring 27 is engaged in the latching groove 213, such that the spring 27 is fixed in the main body 21. The spring 27 divides the chamber 211 into a battery chamber 215 and an additional chamber 217 away from the front cover 23. The battery chamber 215 receives the battery 300. The additional chamber 127 may receive other elements, such as a circuit board.

During assembly of the electronic device 10, the front cover 23 is mounted in an end of the main body 21. The battery 300 is received in the battery chamber 115, and the positive electrode 103 of the battery 100 electrically contacts the electrical conductive pole 145. The spring 27 is compressed and fixed in the chamber 211. The resisting portion 273 resists the negative electrode 105 of the battery 300 to snugly fix the battery 300 in the main body 21 of the battery holder 200.

Referring to FIG. 4, a clamping member 300 can be employed to mount the spring 27 into the main body 21. The clamping member 300 includes a pair of arms 301 and a resilient member 303 interconnecting the pair of arms 301. The arms 301 may be adjusted to move toward to each other. Each arm 301 includes a limiting portion 3011, a body 3013 and a clamping portion 3015. The limiting portion 3011 is formed at an end of the body 3013, and the clamping portion 3015 is formed at the other end of the body 3013. An inner diameter of the main body 21 is slightly less than a diameter of the limiting portion 3011 and an outer diameter of the latching portion 271 of the spring 27. A length of the body 3013 is substantially equal to a distance between the latching groove 213 and the rear cover 25 (shown in FIG. 2). The limiting portion 3011 forms a flange 3017 at an end adjacent to the body 3013. The latching portion 271 of the spring 27 defines a pair of mounting holes 275 corresponding to clamping portions 3015.

Mounting of the spring 27 in the main body 21 includes each clamping portion 3015 being received in the corresponding mounting hole 275. External force on the arms 301 reduces the diameter of the latching portion 271, allowing the spring 27 to be received in the main body 21. When the limiting portion 3011 is blocked by an edge of the main body 21, the latching portion 271 is substantially coplanar with the latching groove 213. The spring 27 is released, and the latching portion 271 decompresses accordingly and latches into the latching groove 213, such that the spring 27 is fixed in the main body 21.

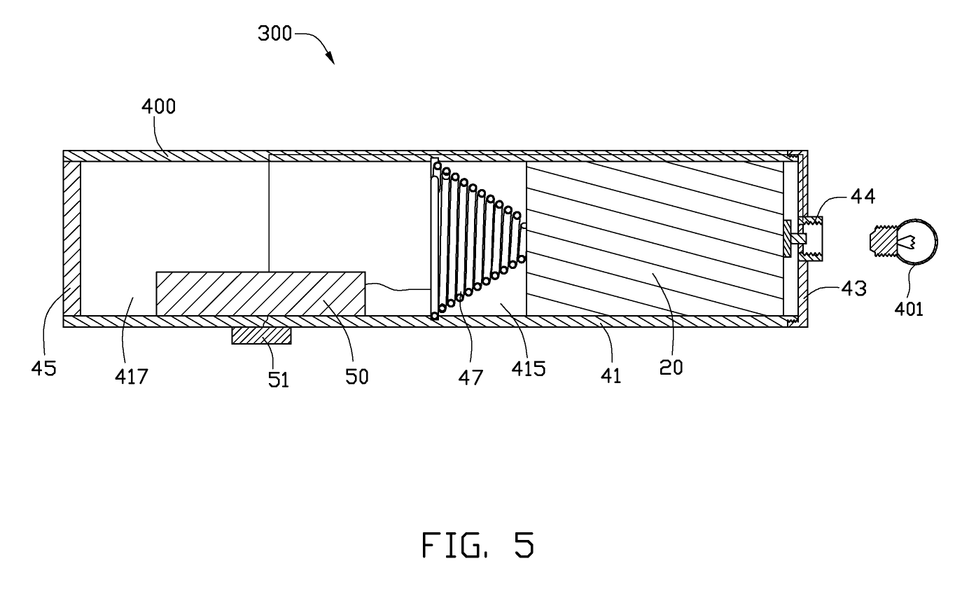

FIG. 5 a cross section of a second embodiment of an electronic device 300 that includes an embodiment of a battery holder 400 and a battery 20 is shown. The second embodiment of the electronic device 200 is similar to the first embodiment of the electronic device 10 except that the electronic device 300 further includes a current limiting module 50 and a switch 51. The current limiting module 50 is received in the additional chamber 417, and electrically connected to the lamp socket 44, the switch 51 and the spring 47 via leads (not labeled). The switch 51 is positioned on an outer surface of the main body 40, and directs the current limiting module 50 to control a brightness of the lamp 101.

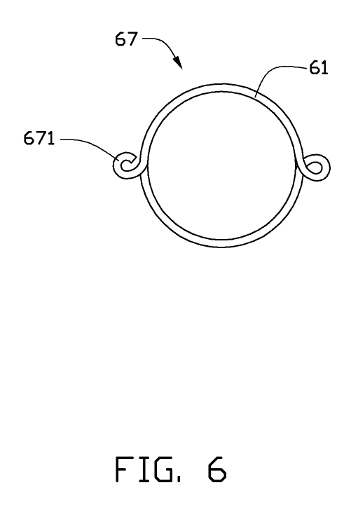

FIG. 6 is a top view of a spring 67 of the electronic device of FIG. 5, differing from the spring 27 of the first embodiment only in that spring 67 is cylindrical, and forms a pair of latching portions 671 opposite to each other at an end. Both of the two latching portions 671 are latched in the latching groove 213. The other end of the spring 67 opposite to the latching portion 671 resists the battery 100. Alternatively, the body 21 can define a pair of latching grooves 213 spaced from each other corresponding to the pair of latching portions 671. Each latching portion 671 engages a corresponding latching groove 213 to fix the spring 67 in the body 21, such that rotation of the battery cover relative to the main body 21 is prevented.

Finally, while the present disclosure has been described with reference to particular embodiments, the description is illustrative of the disclosure and is not to be construed as limiting the disclosure. Therefore, various modifications can be made to the embodiments by those of ordinary skill in the art without departing from the true spirit and scope of the disclosure as defined by the appended claims.

What is claimed is:

1. A battery holder, comprising:
a main body defining a chamber therein and a latching groove in a middle portion of a side surface of the chamber;
a spring comprising a latching portion engaged in the latching groove to fix the spring in the main body, the spring dividing the chamber into a battery chamber and an additional chamber.

2. The battery holder of claim 1, wherein the main body is a substantially cylindrical sleeve made of metallic material.

3. The battery holder of claim 2, wherein the spring is frustoconical in shape and comprises a large end acting as the latching portion, and a small end acting as a resisting portion resisting the battery.

4. The battery holder of claim 3, wherein the latching portion defines a mounting hole.

5. The battery holder of claim 1, further comprising a front cover fixed in an end of the main body and a lamp socket positioned in the front cover.

6. The battery holder of claim 5, wherein the lamp socket comprises a sleeve, an insulating sheet positioned in an end of the sleeve, and an electrically conductive pole received in the insulating sheet and partially received in the sleeve.

7. The battery holder of claim 5, further comprising a rear cover fixed in an end of the main body opposite to the front cover.

8. The battery holder of claim 1, wherein the latching groove is an annular groove extending along a circumference of the chamber.

9. An electronic device, comprising:
a battery holder comprising a main body, a lamp socket, and a spring, the main body defining a chamber therein and a latching groove in a middle portion of an inner sidewall of the chamber, the spring comprising a latching portion engaged in the latching groove to fix the spring in the main body, and the chamber is divided by the spring into a battery chamber and an additional chamber, the lamp socket fixed in an end of the main body adjoining the battery chamber;
a battery received in the battery chamber and electrically contacting the spring and the lamp socket; and
a lamp detachably supported in the lamp socket.

10. The electronic device of claim 9, wherein the main body is a substantially cylindrical sleeve made of metallic material.

11. The electronic device of claim 10, wherein the spring is frustoconical in shape and comprises a large end acting as the latching portion, and a small end acting as a resisting portion resisting the battery.

12. The electronic device of claim 11, wherein the latching portion defines a mounting hole.

13. The electronic device of claim 9, further comprising a front cover fixed in an end of the main body, the lamp socket positioned in the front cover.

14. The electronic device of claim 13, wherein the lamp socket comprises a sleeve, an insulating sheet positioned in an end of the sleeve, and an electrical conductive pole received in the insulating sheet and partially received in the sleeve.

15. The electronic device of claim 13, further comprising a rear cover fixedly disposed in the other end of the main body opposite to the front cover.

16. The electronic device of claim 9, wherein the latching groove is an annular groove extending along a circumference of the chamber.

17. The electronic device of claim 9, wherein the electronic device further comprises a current limiting module received in the additional chamber and electrically connected to the electrically conductive sheet and lamp socket.

18. The electronic device of claim 17, further comprising a switch fixed in the outer surface of the main body and electrically connected to the current limiting module.
